(19) United States
(12) Patent Application Publication
(10) Pub. No.: US 2013/0151335 A1
(43) Pub. Date: Jun. 13, 2013

(54) WIRELESS SMART SHOPPING FRAMEWORK

(71) Applicants: Phani Bhushan Avadhanam, San Diego, CA (US); Nuthan Seegehalli Hanumanthappa, San Diego, CA (US)

(72) Inventors: Phani Bhushan Avadhanam, San Diego, CA (US); Nuthan Seegehalli Hanumanthappa, San Diego, CA (US)

(73) Assignee: QUALCOMM INNOVATION CENTER, INC., San Diego, CA (US)

(21) Appl. No.: 13/313,995

(22) Filed: Dec. 7, 2011

(51) Int. Cl. G06Q 30/02; G06Q 30/06

(52) U.S. Cl. 705/14.53; 705/26.81; 705/26.7; 705/14.64; 705/14.58

(57) ABSTRACT

A wireless smart shopping framework is disclosed. An operator of a retail premises provides displays of products in a product display portion of a retail premises to enable shoppers to view features of the products, but the products are stored in an inventory portion of the retail premises that is separate from the product display portion of the retail premises. Shoppers browse the product display portion of the retail premises and scan product identifying information (e.g., by taking pictures of the displayed products). The operator receives, via a wireless receiver, the product-identifying information for selected products from the wireless mobile communication device, and gathers the selected products from the inventory portion. When the shopper is done shopping, the selected products are moved to a checkout location and payment is received for the selected products.

### BACKGROUND

1. Field

The present invention relates generally to shopping systems and methods, and more specifically to wireless-based shopping systems and methods.

2. Background

When a consumer walks into existing stores (e.g., grocery stores, hardware stores, furniture stores, and general merchandise stores), they are typically forced to push a shopping cart (which often has damaged wheels) through isles while navigating around other shoppers and their carts to select products that are then placed in their shopping cart. In these environments, shoppers then checkout of the store by standing in line, moving items from the shopping cart onto a conveyer belt, and once the items are scanned by store personnel, the items are moved back into the cart again before being taken to the shoppers' car. This process is so cumbersome that many shoppers are led to purchase items from their home from online retailers.

Online shopping, however, has several undesirable drawbacks. Most notably perhaps is that consumers are unable to touch, feel, and see the actual products before the products are purchased. And consumers do not receive the person-to-person sales assistance that many consumers desire and retailers rely upon to build goodwill. Moreover, the hassles associated with returning items (e.g., for a refund or an exchange) that are purchased from online retailers leads many consumers to avoid online shopping altogether. As a consequence, both traditional in-store shopping approaches and online approaches have drawbacks that are very undesirable or otherwise unsatisfactory for many consumers.

### SUMMARY

Consistent with many aspects, the invention may be characterized as a method for shopping at a retail premises with a wireless mobile communication device. The method includes receiving, from a smart shopping component located at the retail premises, an invitation to join a shopping session at the retail premises via a wireless communication receiver of the wireless mobile communication device. In response to receiving the invitation, a shopping application on the wireless communication device is initiated, and the shopper is authenticated to verify the shopper is authorized to access the smart shopping component. The shopper then scans product-identifying information that is made available in connection with displays of the products in the retail premises to select the products for purchase. And the product-identifying information from the products is sent via the wireless transmitter to the smart shopping component to enable personnel of the retail premises to gather selected products for the shopper. The shopper then receives the selected products at a checkout location.

Other aspects of the invention may be characterized as a method for selling items within a retail premises. The method includes providing displays of products in a product display portion of the retail premises to enable shoppers to view features of the products while the products are maintained in a separate inventory portion of the retail premises. Invitations to join a shopping session at the retail premises are sent to shoppers in possession of wireless mobile communication devices, and a unique shopping session is set up for each of the shoppers in response to the shopper accepting the invitation. Product-identifying information for selected products is received via wireless receiver from the shoppers' wireless mobile communication devices. The selected products are then gathered from the inventory portion and moved to a checkout location when the shoppers indicate they are done shopping.

### BRIEF DESCRIPTION OF THE DRAWINGS

FIG. 1 is a diagram depicting an exemplary shopping system consistent with several embodiments;

FIG. 2 is a block diagram depicting components implemented at the retail premises of FIG. 1;

FIG. 3 is a block diagram depicting components of en exemplary wireless mobile communication device;

FIG. 4 is a flowchart depicting methods traversed by operators of the retail premises and the wireless mobile communication device; and

FIG. 5 is a diagram depicting physical components that may be utilized to realize the components depicted in FIGS. 1, 2, and 3.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

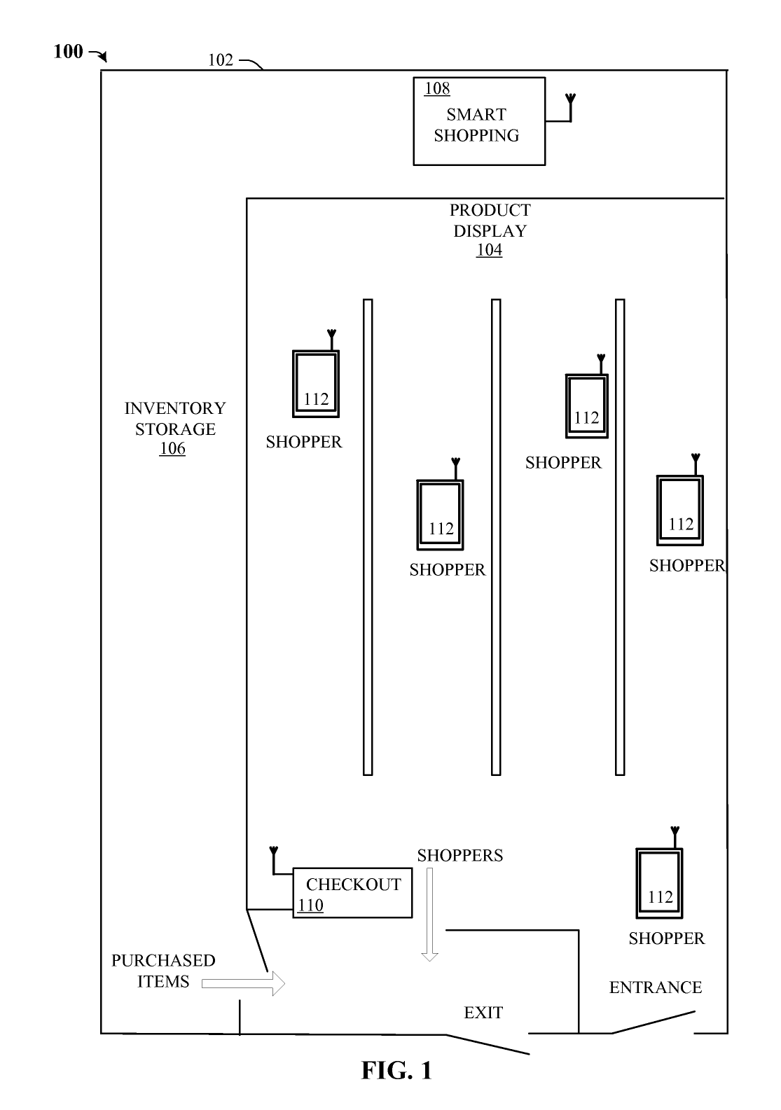

Referring first to FIG. 1, shown is an exemplary embodiment of a shopping system 100. As shown, a retail premises 102 includes a product display section 104 that includes isles for displaying products, an inventory storage section 106, and a smart shopping component 108 that is wirelessly in communication with a checkout component 110 and mobile communication devices 112 that are used by shoppers. In this embodiment, the isles include display products (e.g., just one of each type of product so the shoppers can see the products) and the inventory storage section 106 of the retail premises 102 is used to store an inventory of several of each of the types of products. The mobile communication devices 112 may realized by smartphones, tablets, notebook computers, or other mobile communication device with scanning capability.

The depicted shopping system 100 beneficially retains many aspects of the traditional in-store shopping while providing many improvements and enhancements that enable an enjoyable and impressive experience for shoppers. Some beneficial aspects of traditional in-store shopping that the exemplary system 100 retains include shoppers walking along the product display section 104 viewing and touching displayed products in person, receiving assistance from a “live” sales person, and walking out of the retail premises 102 with products in their hands. But this system removes many of the undesirable aspects of walking through a retail store. For example, shoppers no longer need to push the unwieldy shopping carts through isles that are often crowded with other parked and moving shopping carts. Moreover, shoppers need not go through the cumbersome and time consuming process of unloading their shopping cart on the conveyer at the checkout, waiting for a cashier to scan and bag their products, and then reloading the cart. Thus the present system 100 retains the aspects of traditional in-store shopping that shoppers enjoy while removing many of the unpleasant characteristics of traditional in-store shopping that shoppers hate.

Moreover the exemplary shopping system 100 includes aspects of Internet-based online shopping systems that retailers and/or shoppers value while removing the undesirable aspects of online shopping. In many implementations for example, retailers are able to improve sales and provide extra value to shoppers by sending shopper specific advertisements and product offers to mobile communication devices 112 that are utilized by shoppers in the exemplary system. And in some embodiments shoppers are able to access content such as consumer reviews, pictures, and video content that on-line shoppers enjoy. But the exemplary system 100 provides many benefits that online shopping cannot provide. For example, shoppers in the exemplary system are able to view, touch, measure, and potentially try out the products before they decide to buy them instead of only looking at pictures or videos. And people often prefer to speak to a live salesperson and ask sales personnel questions face-to-face in real time. And in addition, many people enjoy the social aspects getting out of the house to meet and talk with other people, and people also enjoy the health benefits of getting exercise while shopping. Thus, the exemplary system 100 provides a collection of beneficial aspects that neither online retailers nor traditional “brick and mortar” retailers can provide.

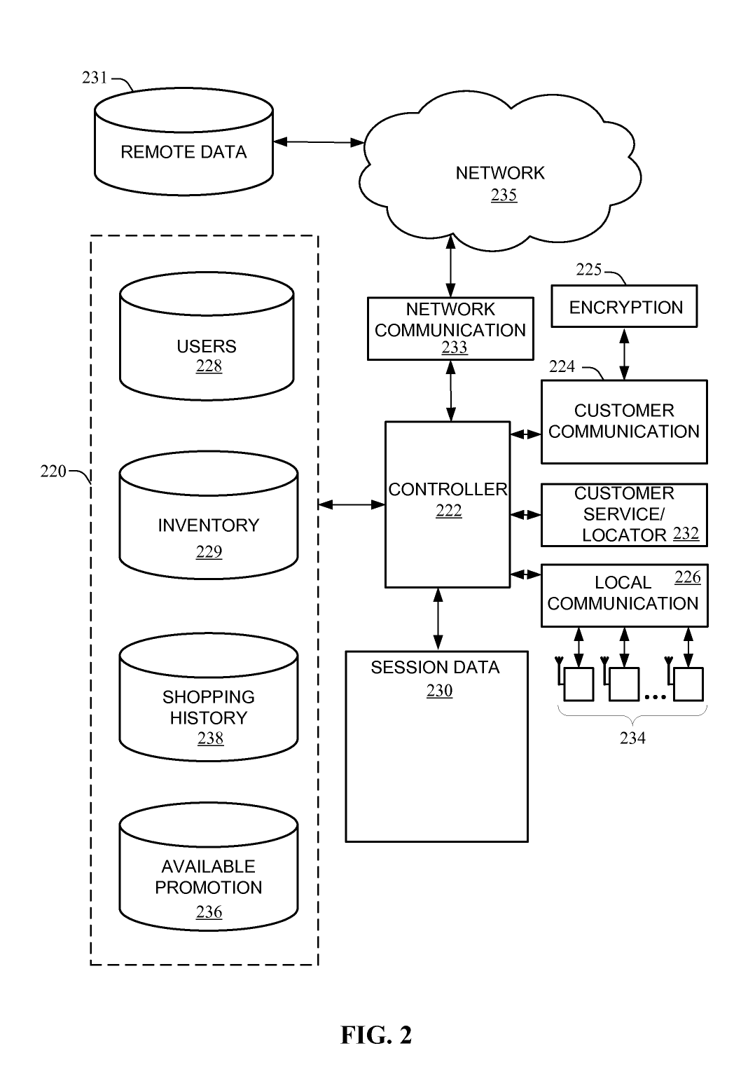

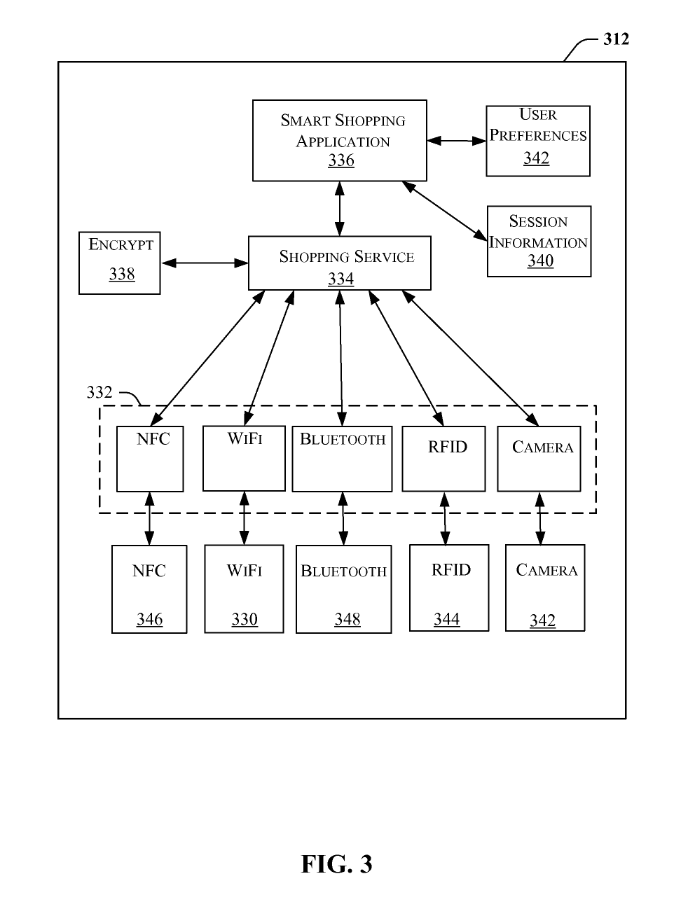

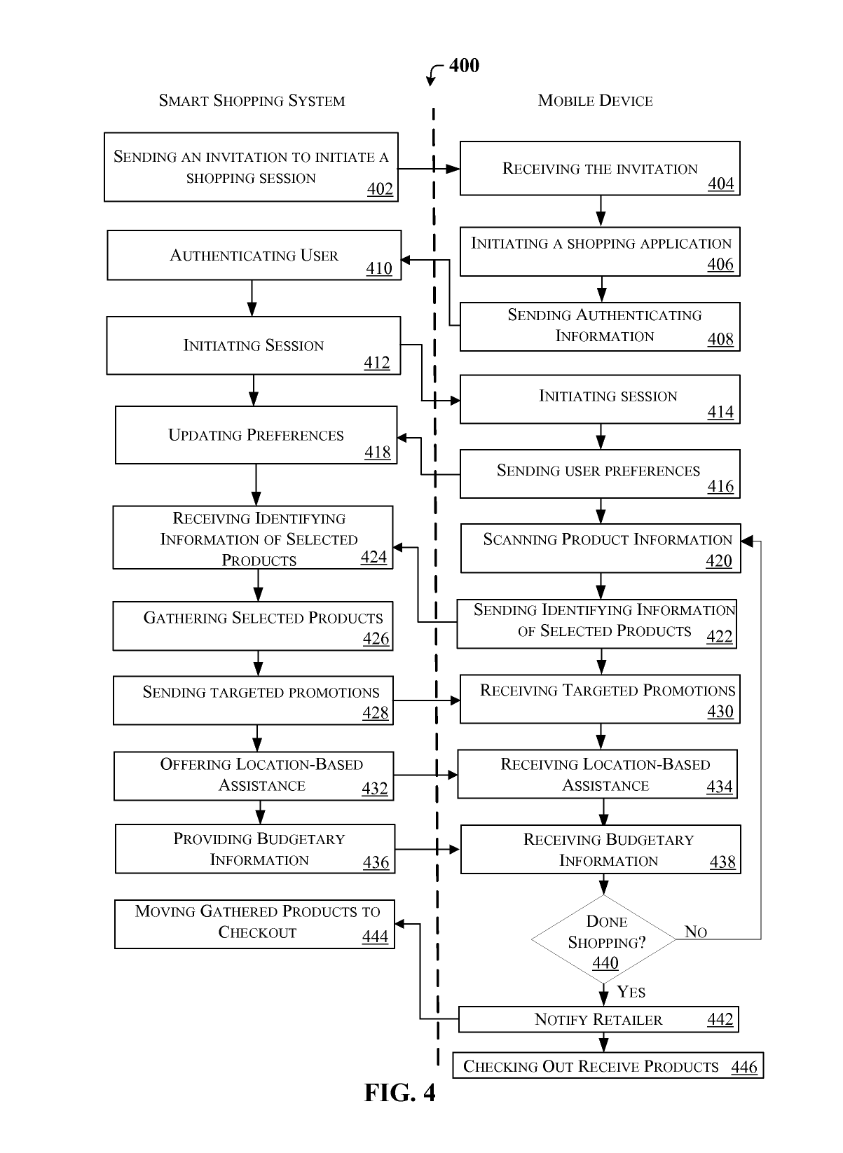

While referring to FIG. 1, reference will also be made to FIGS. 2 and 3, which are exemplary embodiments, respectively, of the smart shopping component 108 and the mobile communication devices 112 depicted in FIG. 1. The depiction of the components in FIGS. 2 and 3 is logical and is not intended to be an actual hardware diagram. For example, the division of the databases 220 in FIG. 2 into four databases is for exemplary purposes only, and each of the databases 220 may be further separated into discrete databases or may be further integrated. It should also be recognized that the databases 220 may reside within the premises 102, may be located remotely from the premises 102 or may be distributed among the premises 102 and remote locations. Moreover, one of ordinary skill in the art will appreciate in view of this disclosure that the components may be realized by hardware, software, firmware, or combinations thereof. In addition, reference is also made to FIG. 4, which is a flowchart depicting the interaction between the smart shopping component 108 and each of the mobile communication devices 112.

When the shoppers enter the retail premises 102, the smart shopping component 108 prompts each of the mobile communication devices 112 with an invitation to initiate a shopping session and accept the incoming traffic from the smart shopping component 108 (Block 402). As shown in FIG. 2 for example, a controller 222 in connection with a customer communication component 224 and a local communication component 226 initiates the invitations to shoppers. The controller 222 in this embodiment generally functions to coordinate and control operations of the smart shopping component 108, and the customer communication component 224 generally operates to facilitate initial and ongoing communications with the shoppers once the shoppers have registered with the smart shopping component 108. And the local communication component 226 generally operates to wirelessly transmit and receive communications from the mobile communication devices 112.

In many implementations for example, the local communication component 226 utilizes a plurality of WiFi access points 234 that are distributed about the premises 102 to enable wireless communications between the mobile communication devices 112 and the smart shopping component 108 while the shoppers are in the premises 102. It should be recognized that WiFi is only an exemplary technology and that other wireless communications and protocols may be utilized to communicate with the wireless communication devices 112.

When the mobile communication devices 112 receive the invitation (Block 404), a WiFi component 330 receives the signals from the local communication component 226 of the premises 102, and in response to the WiFi component 330 receiving the invitation, a WiFi driver (shown among a collection of drivers 332) provides corresponding signals, which may be a service event, to a shopping service 334. And the shopping service 334 may prompt a smart shopping application 336 to be automatically launched (Block 406). Once the smart shopping application 336 is presented to a user, the smart shopping application 336 may confirm that the user/shopper wants to initiate a shopping session with the smart shopping component 108 and then prompt the user to enter credentials (e.g., a user name and password), which are encrypted by the encryption component 338 and sent to the shopping service component 334 (Block 408). The controller 222 receives the encrypted credentials, and the customer communication component 224 decrypts the credentials using an encryption component 225 so the controller 222 may access a user database 228 to confirm the shopper/user is authorized to engage with the smart shopping component 108 (Block 410). In addition to credentials, the user database 228 may include other information about each of the shoppers including preferred payment sources (e.g., credit, checking, Paypal, etc.).

Once authenticated, a session is initiated between the smart shopping component 108 and the mobile communication device 112 (Blocks 412, 414), and system session data 230 is generated by the controller 222 at the smart shopping component 108 and device session data 340 is generated by the application 336 on the mobile communication device 112.

In addition, once the session is initiated the smart shopping application 336 may access user preferences 342 that are stored on the mobile communication device 112 and send them to the smart shopping component 108 (Block 416) so the controller 222 may update one or more of the databases 220 with the user preferences (Block 418). For example, the user preferences may include data that indicates, for each particular retail establishment that the user has registered with in the past, the type of credit card or particular bank account the user prefers to use with that particular retailer. In addition, the shopper may provide budgetary information to the smart shopping component 108 so that the shopper may receive alerts or alternative product suggestions as discussed below in connection with Blocks 436 and 438.

Once a session is initiated, all the transactions between the mobile communication device 112 and the smart shopping component 108 are local to the retail premises 102. And the smart shopping application 336 running on each of the mobile communication devices 112 will make sure no similar transactions are allowed with other systems outside the retail premises 102. So if there is another retailer in close proximity to the premises 102 for example, the shopper will only receive advertisements from the retail premises 102 where the shopper has been registered.

In addition, in many implementations communications between the mobile communication devices 112 and the smart shopping component 108 are encrypted and decrypted by the encryption components 338, 225 (using any techniques well known to those of ordinary skill in the art) so that details about the types of items being purchased by the shoppers cannot be intercepted. This helps to ensure the protection of privacy and avoid spamming. In addition, the smart shopping component 108 adds each of the mobile communication devices 112 to a broadcast list that is maintained by the customer communication component 224, which indicates the mobile communication devices 112 that the system 100 may communicate with.

During a session, the shopper walks up and down the aisles looking at products (just as they would in a typical retail “brick and mortar” establishment), but instead of picking up a product and placing a product in their basket when they want to buy it, the shopper scans identifying information from the product with their mobile communication device 112 (Block 420) and sends the identifying information (e.g., via the WiFi connection) to the smart shopping component 108 (Block 422). In many embodiments the shoppers scan product information by simply taking a photograph of the displayed product with the camera 342 of the mobile communication device 112. But using photographs is certainly not required and in alternative embodiments the RFID component 344, NFC component 346, or other types of sensors may be used to scan product information.

The exemplary system 100 also enables shoppers to access product-information content via the mobile communication devices 112 to help shoppers make purchasing decisions. This product-information content may be generated from product suppliers or from independent third parties. The content may be stored locally within the databases 220 or may be accessed from remote database 231, and the content may include consumer reviews and product rating information as well as photos or videos that depict how products are used.

When a shopper selects a product for purchase, the selected product information is then stored with the session information 340, and when received at the smart shopping component 108 (Block 424) an inventory database 229 is accessed to determine whether the product is available in the inventory storage section 106 of the retail premises 102. And if the product is available, the smart shopping component 108 will update session data 230 to include the selected product. Although the databases 220 may reside locally within the retail premises 102, this is certainly not required and in alternative implementations some or all of the databases 220 may reside in remote databases 231, which may be coupled to the controller 222 via a network communication component 233 and networks 235 (e.g., the Internet).

After the smart shopping component 108 has updated the session data 230 personnel or automated systems (e.g., robotic systems) will use the identifying information to gather the selected products the shopper is purchasing from the inventory storage section 106 of the retail premises 102 (Block 426). And by the time the shopper is done shopping, the list of all the items that the shopper desires to purchase will be sent to the smart shopping component 108 where personnel of the retail premises 102 can make the products available to the user.

Because the smart shopping component 108 includes a shopping history database 238 with information about past purchases made by users, and the session data 230 includes data about current purchases, targeted promotions such as advertisements, coupons, alternate products, or simply additional information on the products can be pushed to the mobile communication devices 112 (Block 428), which are received at the mobile communication devices 112 (Block 430), and the smart shopping application 336 running on the mobile communication devices 112 will display the promotions to the user. If the shopper selects one or more products or services offered via the promotions, those products and/or services will also be added to the list of selected items in the session data 230, 340.

In addition to an awareness of what the shoppers are purchasing, a customer service/locator component 232 also maintains an awareness of where the shoppers are in the retail premises 102 and a length of time that each of the shoppers has been located at a particular location; thus the smart shopping component 108 also offers assistance based upon the shopper's location in the retail premises 102 (Block 432). For example, techniques for identifying a location of each the shoppers using the multiple WiFi access points 234 are known to those of ordinary skill in the art, and this information may be used to provide more targeted promotional information to the shoppers. More specifically, the particular location of the shopper in the premises may be used to identify the products that a shopper is in close proximity to, and this information, in connection with promotion information from the promotion database 236, may be used to send promotional information (e.g., an advertisement for a product that is on clearance within close proximity to the shopper). Thus the location of the shoppers may be used in connection with the targeted promotions that are sent at Block 428.

In addition, the awareness of the specific locations of customers in the retail premises can be used be the retailer to negotiate better deals with the companies that want to promote their products. More specifically, because the locations of consumers are known and can be tracked, the retailer knows when consumers are in the vicinity of a particular product shelf. As a consequence, the management of the retailer can leverage this valuable information to negotiate with outside/third parties that will want to use that shelf space for advertising campaigns.

By way of further example, the location of a shopper may be used in connection with the history of the shopper in the shopper history database 238 to provide intelligent promotional information to shoppers. More specifically, if a shopper has made particular purchases in the past, the shopper may be informed that the shopper is in close proximity to the products that the shopper purchased in the past.

In addition, if the shopper has been at a particular location within the premises 102 for a threshold period of time (e.g., five minutes) the customer service/locator component 232 may send a customer-service inquiry that is received via WiFi communication at a mobile communication device 112 to ask a shopper whether the shopper needs assistance (Block 434). And if the shopper has been at the location for a longer period of time (e.g., ten minutes or more) the customer service/locator component 232 may prompt customer service personnel to meet the shopper and provide personal assistance to the shopper.

Moreover, the information about the length of time consumers are at particular locations may be used by the management of the retailer to better market their products. For example, if shoppers are consistently spending a length of time at a particular location that exceeds a threshold, the store management may consider redesigning the shelves or display of the products in that particular location to better manage the store layout. This gives an opportunity for the store management to effectively increase the customer satisfaction, and manage the layout of premium “real estate” in the store in the best possible way.

As depicted in FIG. 4, yet another beneficial aspect of the smart shopping component 108 is its ability to provide budgetary information to shoppers (Block 436). In some embodiments for example, a shopper may provide a limit (e.g., in terms of dollars) that the shopper wants to spend in the store. In other embodiments, the controller 222 may retrieve and retain information about a shopper's available funds or available credit in user database 228. In these embodiments, store management can suggest some alternate products with similar functionality that may cost less or the shoppers may simply be warned that they are approaching their spending limit. The smart shopping application 336 running on the mobile communication devices 112 will receive these messages and display the proper suggestion or alert to the user (Block 438). Beneficially, when shoppers are made aware of budgetary constraints, shoppers are less likely to select more products than they can pay for; thus saving shoppers the hassle and embarrassment of removing items from their cart at checkout, and saving the retailer time that would ordinarily be spent restacking items returned at the checkout counter.

As shown, when a shopper is done shopping (Block 440), the smart shopping component 108 is notified that the shopper has completed shopping (Block 442), which prompts the personnel and/or automated processing system to finalize the gathering of the products and move the products to the checkout location 110 (Block 444). And the shoppers finalize the checkout process by confirming their purchase, paying, and receiving the products (Block 446). Because the smart shopping component 108 maintains the list of items the shopper has purchased in the session data, a textual listing and/or photographs of the items that the shopper purchased may be displayed for the shopper at the checkout location 100, and retail personnel at the checkout location 100 may receive a confirmation from the shopper that the listed items are those that the shopper purchased. The shopper may then issue a final payment authorization using the near field communication (NFC) component 346, Bluetooth component 348 or any traditional or yet-to-be developed payment schemes. Once payment is made, in many implementations a receipt will be sent to a preregistered email address or phone number of the mobile communication device 112 via short message service (SMS) messages.

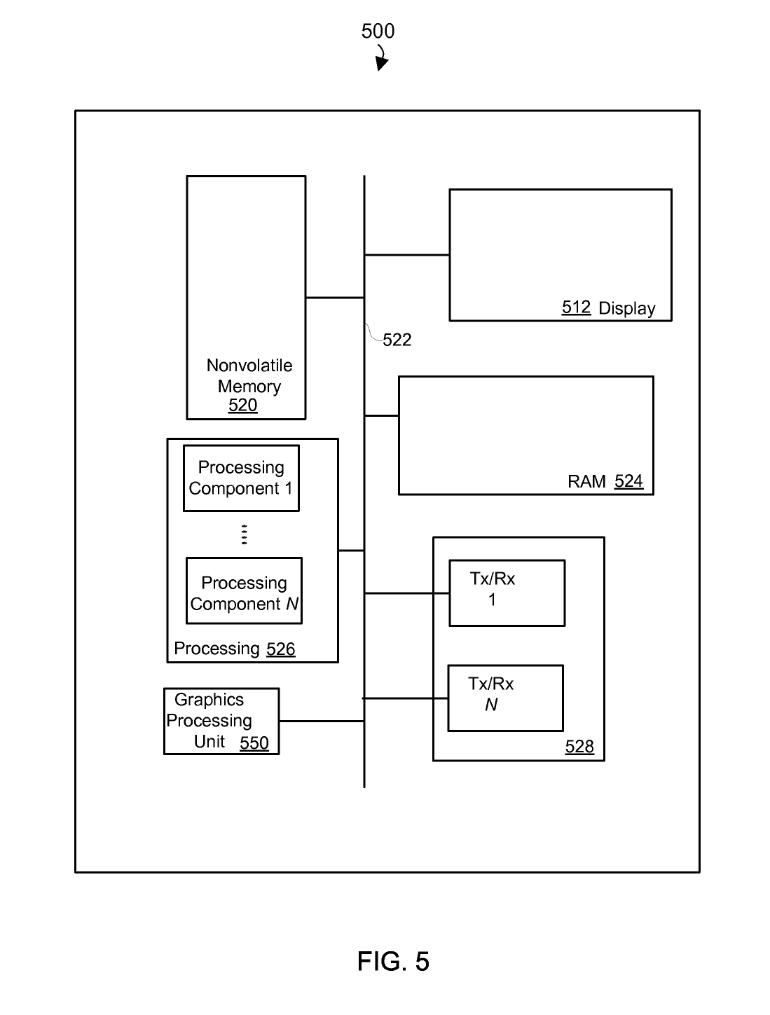

Referring next to FIG. 5, shown is a block diagram 500 depicting physical components that may be utilized to realize the smart shopping component 108, checkout component 110, and mobile communication devices 112 described with reference to FIGS. 1-3. As shown, a display portion 512, and nonvolatile memory 520 are coupled to a bus 522 that is also coupled to random access memory (“RAM”) 524, a processing portion (which includes N processing components) 526, a transceiver component 528 that includes N transceivers, and a graphics-processing component 550. Although the components depicted in FIG. 5 represent physical components, FIG. 5 is not intended to be a hardware diagram; thus many of the components depicted in FIG. 5 may be realized by common constructs or distributed among additional physical components. Moreover, it is certainly contemplated that other existing and yet-to-be developed physical components and architectures may be utilized to implement the functional components described with reference to FIG. 5.

This display portion 512 generally operates to provide a presentation of content to a user, and in several implementations, the display is realized by an LCD or OLED display. In general, the nonvolatile memory 520 functions to store (e.g., persistently store) data and executable code including code that is associated with the functional components depicted in FIGS. 1-3. In some embodiments for example, the nonvolatile memory 520 includes bootloader code, modem software, operating system code, file system code, and code to facilitate the implementation of one or more portions of the components discussed in connection with FIGS. 1-3.

In many implementations, the nonvolatile memory 520 is realized by flash memory (e.g., NAND or ONENAND™ memory), but it is certainly contemplated that other memory types may be utilized as well. Although it may be possible to execute the code from the nonvolatile memory 520, the executable code in the nonvolatile memory 520 is typically loaded into RAM 524 and executed by one or more of the N processing components in the processing portion 526.

The N processing components in connection with RAM 524 generally operate to execute the instructions stored in nonvolatile memory 520 to effectuate the functional components depicted in FIGS. 1-3. As one of ordinarily skill in the art will appreciate, the processing portion 526 may include a video processor, modem processor, DSP, and other processing components.

The depicted transceiver component 528 includes N transceiver chains, which may be used for communicating with external devices via wireless networks. Each of the N transceiver chains may represent a transceiver associated with a particular communication scheme.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for shopping at a retail premises with a wireless mobile communication device, the method comprising:
receiving, from a smart shopping component located at the retail premises, an invitation to join a shopping session at the retail premises via a wireless communication receiver of the wireless mobile communication device;
initiating, in response to receiving the invitation, a shopping application on the wireless communication device;
authenticating a shopper is authorized to access the smart shopping component to enable a unique shopping session for the shopper to be initiated at the smart shopping component;
scanning product-identifying information that is made available in connection with displays of products in the retail premises to select the products for purchase;
sending the product-identifying information via a wireless transmitter to the smart shopping component to enable personnel of the retail premises to gather the selected products for the shopper; and
receiving the selected products at a checkout location.

2. The method of claim 1, wherein the authenticating includes encrypting and sending credentials to the smart shopping component.

3. The method of claim 1, wherein the wireless mobile communication device will not provide communications from other retail premises to the shopper while the wireless mobile communication device is within the retail premises.

4. The method of claim 1, wherein scanning includes taking photographs of the displays of the products.

5. The method of claim 1, wherein scanning includes scanning the product-identifying information using one of near field communication (NFC) technology, radio frequency identification (RFID) technology, or bar code scanning technology.

6. The method of claim 1 including:
receiving promotional information from the smart shopping component at the mobile communication device, the promotional information is based upon one or more of a shopping history of the shopper, preferences of the shopper, or budgetary constraints of the shopper.

7. The method of claim 1, including:
receiving sales assistance based upon a location of the shopper in the retail premises.

8. The method of claim 1, including:
receiving an indication at the wireless mobile communication device that the shopper has reached a spending limit.

9. The method of claim 8, including:
receiving a suggestion at the wireless mobile communication device that a less expensive item is available.

10. A method for selling items within a retail premises, the method comprising:
providing displays of products in a product display portion of the retail premises to enable shoppers to view features of the products, the displays of products including product-identifying information;
maintaining the products in an inventory portion of the retail premises that is separate from the product display portion of the retail premises;
sending, via a wireless transmitter, an invitation to join a shopping session at the retail premises to a shopper in possession of a wireless mobile communication device;
initiating a unique shopping session for the shopper at a smart shopping component in response to the shopper accepting the invitation;
receiving, via a wireless receiver, product-identifying information for selected products from the wireless mobile communication device;
gathering the selected products from the inventory portion;
moving the selected products to a checkout location in response to receiving an indication from the wireless communication device that the shopper is done shopping; and
receiving payment for the selected products.

11. The method of claim 10, wherein the product-identifying information includes digital images of the products that were captured by a camera of the wireless mobile communication device.

12. The method of claim 10, wherein the product-identifying information includes digital data captured by a sensor of the wireless mobile communication device, wherein the sensor is one of an NFC sensor, RFID sensor, or optical sensor.

13. The method of claim 10, including:
sending promotions to the wireless mobile communication device.

14. The method of claim 13, including:
maintaining a history of the purchases made by the shopper;
wherein the promotions are generated based upon the history of the purchases made by the shopper.

15. The method of claim 13, wherein the promotions are based upon a location of the shopper in the product display portion of the retail premises.

16. The method of claim 10, including:
tracking a location of the shopper within the product display portion of the retail premises; and
providing assistance to the shopper when the shopper remains at a location for a length of time that exceeds a threshold.

17. The method of claim 16, wherein the assistance includes sending an inquiry to the wireless mobile communication device that asks the shopper whether the shopper would like sales assistance.

18. The method of claim 16, wherein the assistance includes sending store personnel to the location of the shopper to assist the shopper.

19. The method of claim 10, including:
receiving an indication of a spending limit for the shopper; and
assisting the shopper to remain below the spending limit.

20. The method of claim 19, wherein assisting the shopper to remain below the spending limit includes sending suggestions to the mobile wireless communication device for alternative products than those selected by the shopper.

21. A non-transitory, tangible computer readable storage medium, encoded with processor readable instructions to perform a method for shopping at a retail premises with a wireless mobile communication device, the method comprising:
receiving, from a smart shopping component located at the retail premises, an invitation to join a shopping session at the retail premises via a wireless communication receiver of the wireless mobile communication device;
initiating, in response to receiving the invitation, a shopping application on the wireless communication device;
authenticating a shopper is authorized to access the smart shopping component to enable a unique shopping session for the shopper to be initiated at the smart shopping component;
scanning product-identifying information that is made available in connection with displays of products in the retail premises to select the products for purchase;
sending the product-identifying information via a wireless transmitter to the smart shopping component to enable personnel of the retail premises to gather the selected products for the shopper.

22. The non-transitory, tangible computer readable storage medium of claim 21, wherein the authenticating includes encrypting and sending credentials to the smart shopping component.

23. The non-transitory, tangible computer readable storage medium of claim 21, wherein the wireless mobile communication device will not provide communications from other retail premises to the shopper while the wireless mobile communication device is within the retail premises.

24. The non-transitory, tangible computer readable storage medium of claim 21, wherein scanning includes taking photographs of the displays of the products.

25. The non-transitory, tangible computer readable storage medium of claim 21, wherein scanning includes scanning the product-identifying information using one of near field communication (NFC) technology, radio frequency identification (RFID) technology, or bar code scanning technology.

26. The non-transitory, tangible computer readable storage medium of claim 21, the method including:
receiving promotional information from the smart shopping component at the mobile communication device, the promotional information is based upon one or more of a shopping history of the shopper, preferences of the shopper, or budgetary constraints of the shopper.

27. The non-transitory, tangible computer readable storage medium of claim 21, the method including:
receiving sales assistance based upon a location of the shopper in the retail premises.

28. The non-transitory, tangible computer readable storage medium of claim 21, including:
receiving an indication at the wireless mobile communication device that the shopper has reached a spending limit.

29. The non-transitory, tangible computer readable storage medium of claim 28, the method including:
receiving a suggestion at the wireless mobile communication device that a less expensive item is available

30. A wireless mobile communication device comprising:
a wireless communication receiver;
a wireless transmitter;
means for receiving, from a smart shopping component located at the retail premises, an invitation to join a shopping session at the retail premises via the wireless communication receiver of the wireless mobile communication device;
means for authenticating a shopper is authorized to access the smart shopping component to enable a unique shopping session for the shopper to be initiated at the smart shopping component;
means for scanning product-identifying information that is made available in connection with displays of products in the retail premises to select the products for purchase;
means for sending the product-identifying information via the wireless transmitter to the smart shopping component to enable personnel of the retail premises to gather the selected products for the shopper.

31. The wireless mobile communication device of claim 30, wherein the means for authenticating includes means for encrypting and means for sending credentials to the smart shopping component.

32. The wireless mobile communication device of claim 30, including means for preventing communications from other retail premises from reaching the shopper while the wireless mobile communication device is within the retail premises.

33. The wireless mobile communication device of claim 30, wherein means for scanning includes means for taking photographs of the displays of the products.

34. The wireless mobile communication device of claim 30, wherein means for scanning includes means for scanning the product-identifying information using one of near field communication (NFC) technology, radio frequency identification (RFID) technology, or bar code scanning technology.

35. The wireless mobile communication device of claim 30 including:
means for receiving promotional information from the smart shopping component at the mobile communication device, the promotional information is based upon one or more of a shopping history of the shopper, preferences of the shopper, or budgetary constraints of the shopper.

36. The wireless mobile communication device of claim 30, including:
means for receiving sales assistance based upon a location of the shopper in the retail premises.

37. The wireless mobile communication device of claim 30, including:
means for receiving an indication at the wireless mobile communication device that the shopper has reached a spending limit.

38. The wireless mobile communication device of claim 30, including:
means for receiving a suggestion at the wireless mobile communication device that a less expensive item is available.
